(19) United States
(12) Patent Application Publication
(10) Pub. No.: US 2026/0226685 A1
(43) Pub. Date: Aug. 6, 2026

(54) CHEMICAL WOOD PULP WITH ENHANCED TENSILE STRENGTH

(71) Applicant: Södra Skogsägarna ekonomisk förening, Växjö (SE)

(72) Inventors: Fredrik Wernersson Brodin, Kungsbacka (SE); Harald Brelid, Göteborg (SE)

(73) Assignee: Södra Skogsägarna ekonomisk förening, Växjö (SE)

(21) Appl. No.: 19/153,070

(22) PCT Filed: Feb. 5, 2024
(86) PCT No.: PCT/EP2024/052786

§ 371 Date: Aug. 1, 2025

(30) Foreign Application Priority Data
Feb. 6, 2023 (SE) 2350110-9

(51) Int. Cl. D21H 11/02; D21C 3/02; D21C 9/16

(52) U.S. Cl. CPC D21H 11/02; D21C 3/026; D21C 9/163

(57) ABSTRACT

The present inventive concept relates to a method for production of chemical wood pulp. The method comprises: a) providing wood pulp; b) providing xylan-rich fiber material, the xylan-rich fiber material being at least partly delignified; c) mixing the xylan-rich fiber material with an alkaline solution thus forming a xylan-rich alkaline slurry; d) adding the xylan-rich alkaline slurry to the wood pulp thus providing a pulp mixture, wherein the step d) is followed by at least one of: e) oxygen delignification step and/or, f) alkaline bleaching step, to enable reuse of the alkali in the xylan-rich alkaline slurry from step c) in step e) and/or step f).

### TECHNICAL FIELD

The present invention relates to a method for production of chemical wood pulp which comprises resorption of solubilized xylan polymers from a hemicellulose source onto the fibers of the pulp to obtain a strengthened pulp with translocated xylan.

### BACKGROUND

Wood and annual plants, such as agricultural crops/residues, are lignocellulosic materials, which consist primarily of cellulose, hemicelluloses, and lignin. Lignocellulosic plants are complex, natural cellular composite materials composed of several types of cells. The cellulose is the major constituent of the cell walls in plants, and it consists of a fibrillar cellulose portion made from aligned polymeric chains with strong associated bonds between adjacent chains. The lignin is a three-dimensional polymeric material, which binds the cells together. It is also distributed within the cell walls. Lignin provides strength and rigidity to the plants. The hemicelluloses are a type of polysaccharides that is a component of the cell walls of the plants. The two major classes of hemicelluloses are glucomannans and xylans. The xylan content may differ depending on the type of wood material. Typically, hardwood has higher xylan content than softwood.

Pulp is a fibrous material prepared by chemically or mechanically separating elongated cells (fibers) from wood, annual plants, wastepaper, or rags. The pulp produced is the major raw material used in papermaking and the industrial production of other paper products. Industrial pulping involves the large-scale liberation of fibers from lignocellulosic plant material, by either mechanical or chemical processes. Chemical wood pulping involves chemical treatments of the wood material aiming for dissolution of the lignin that binds the fibers together. The processes principally used in chemical pulping are kraft, sulfite, and soda. Chemical pulp is among others used for high-quality white paper and other high-quality paper products. Mechanical pulping involves the pre-treatment of wood with steam (possibly combined with a mild chemical treatment) prior to the separation into fibrous material by abrasive refining or grinding.

The papermaking properties of pulp fibres depend mainly on fiber dimensions and fibre properties, fibre length, coarseness, fibre flexibility etc., but also on the chemical composition of the fibres. It has, for example, been noted that a high xylan content in the pulp fibres contributes to a high tensile strength of the paper produced. Additionally, it is well known that adding released xylan to pulp fibers under the right conditions leads to sorption of the xylan on the pulp fibers, which is positive for the properties of the pulp. This may be achieved by resorption of solubilized xylan polymers from a hemicellulose source in a bulk liquid onto the fibers of the pulp to obtain a strengthened pulp with translocated xylan.

It may thus be desired to make method for production of chemical pulp with translocated xylan which is more efficient and less material consuming than prior art solutions.

### SUMMARY OF THE INVENTION

In view of the above, the present inventive concept relates to a method for alkaline swelling of xylan-rich fiber followed by xylan sorption on a wood pulp in an oxygen delignification step alternatively in a bleaching step, which method is more efficient than prior art solutions and also readily up scalable.

According to a first aspect of the present inventive concept, a method for production of chemical wood pulp is provided. The method comprises:
a) providing wood pulp;
b) providing xylan-rich fiber material; the xylan-rich fiber material being at least partly delignified;
c) mixing the xylan-rich fiber material with an alkaline solution thus forming a xylan-rich alkaline slurry;
d) adding the xylan-rich alkaline slurry to the wood pulp thus providing a pulp mixture, wherein the step d) is followed by at least one of:
e) oxygen delignification step and/or,
f) alkaline bleaching step,
to enable reuse of the alkali in the xylan-rich alkaline slurry from step c) in step e) and/or step f).

The present invention presents a method suitable for industrial implementation of controlled xylan sorption. To achieve this, it is advantageous to have: a source of xylan in the form of partly or extensively delignified xylan-rich fibers, a position in the mill where it is possible to achieve high hydroxide ion concentration for swelling/extraction under conditions limiting the consumption of hydroxide ions, and an addition point for the xylan-rich alkaline slurry where it is mixed with pulp under alkaline conditions and preferably also high ionic strength and sufficiently long residence time for the sorption of xylan. An additional advantage of the present method is that sorption is conducted in a process position where alkali is consumed i.e. pH is gradually decreased, which in turn reduces xylan solubility and favors further xylan sorption.

By mixing a xylan-rich fiber material with an alkaline solution to solubilize xylan from the xylan-rich fiber material and adding the resulting mixture (fibers, alkali and dissolved xylan) to the fiber line of a chemical wood pulping process in a stage where the alkali in the mixture is used as alkali source, the properties of the pulp mixtures may be improved, and the utilization of the charged alkali is maximized. Xylan provided by the xylan-rich fiber material solubilizes in the alkaline solution and sorbs to the wood fibers as the pH of the pulp mixture decreases during oxygen delignification and/or during alkaline bleaching. The added fiber material will be a part of the final pulp product which improves the yield of the obtained pulp mixture.

Adding a xylan-rich alkaline slurry containing both fibers and dissolved xylan to the wood pulp, without prior separation, reduces the need for an extra separation step, such as filtration, which results in a less complex process and enables double use of the charged alkali; to solubilize xylan and to act as a reactant with lignin during oxygen delignification and/or during alkaline bleaching. Hereby, the total amount of alkali used in the method is kept on a low level which is beneficial for both economic and environmental reasons. In other words, the added alkali is to a great extent replacing alkali that is added in the process, i.e. the total alkali requirement is only marginally affected.

The oxygen delignification or bleaching stage may thus be used both for further delignification of the pulp mixture and for resorption of xylan.

The term “wood pulp” may relate to softwood pulp, such as never dried softwood kraft pulp.

The term “xylan-rich fiber material” may incorporate both partly and extensively delignified lignocellulosic fiber material. Delignification of the xylan-rich fiber material may be employed by delignification and/or bleaching. The xylan-rich fiber material may be priorly delignified to a kappa number less than 50, preferably less than 30, more preferably less than 10. The kappa number being analysed by standard method SS-ISO 302:2016.

An advantage of using a delignified xylan-rich fiber material is that the purity of the solubilized xylan in the xylan-rich alkaline slurry is increased. Hereby, a xylan-rich alkaline slurry with high amount of solubilized xylan and low amount of lignin bonded to the solubilized xylan may be provided. A further advantage of using a delignified xylan-rich fiber material with high purity due to prior delignification and/or bleaching (low lignin content, high brightness) is the possibility to add the xylan-rich alkaline slurry formed in step c) late in the process, e.g. at the last alkaline bleaching step in a bleaching plant, without negative effect of the final brightness of the pulp mixture as demonstrated in Example 2.

It should be mentioned that the possibility to add the xylan-rich alkaline slurry in different steps during oxygen delignification and bleaching is beneficial for the properties of the final pulp mixture. By adding the xylan-rich alkaline slurry in a plurality of steps during oxygen delignification and/or bleaching, the amount of sorbed xylan may be increased, at the same time as the use of alkali in the xylan-rich alkaline slurry is maximized.

Delignification and/or bleaching of the xylan-rich fiber material may be conducted in the same pulp mill as where the pulp mixture is delignified and/or bleached. Alternatively, delignification and/or bleaching of the xylan-rich fiber material and the pulp mixture, respectively, may be conducted at different pulp mills. In that event, the xylan-rich fiber material may be delivered as a market pulp and wet defibrated in a “hydro pulper”, dry defibrated in a shredder or defibrated in similar devices before it is mixed with the alkaline solution in step c).

In the method, both hardwood pulp and agro-based pulp may be used as xylan source. Hence, pulp mixtures containing everything from 100% wood-based fibers to pulp mixtures with a partially agro-based content may be achieved. The xylan-rich fiber material may thus originate from hardwood. Alternatively, or additionally, the xylan-rich fiber material may originate from agricultural feedstock, such as agricultural-based fibers. When using agricultural fibers, it is an advantage to use a priorly processed agricultural feedstock in order to avoid high intake of impurities such as lignin and silica. The xylan-rich fiber material may contain at least 15% xylan, preferably at least 20% xylan. Typically, xylan content in fiber material originating from hardwoods is 10 to 35%, whereas xylan content is 6 to 14% in fiber material originating from softwoods. Hereby, hardwood is a preferred source for xylan-rich fiber material.

The method may further comprise a step of:
i) washing and dewatering the pulp mixture thus forming a dewatered pulp mixture and a washing filtrate; wherein step i) occurs after step e) or f). The washing filtrate may be added to the xylan-rich alkaline slurry before step d). The washing filtrate may also or alternatively be added to the wood pulp before step d), such as for use as dilution liquid. The machine equipment used for washing and dewatering can for example be a wash press or a vacuum filter.

The method may further comprise a step of:
j) refining the xylan-rich fibers; wherein the step j occurs before step d). The refining may be conducted either in wet stage or dry stage. An example of refining is grinding.

The xylan-rich fiber material may have a dry matter content of at least 20%, preferably at least 30%. An advantage of using a relatively high dry matter content is that the concentration of hydroxide ions/pH stays high during the swelling of the xylan-rich fibers which promotes the xylan extraction.

The addition of the xylan-rich slurry to the wood pulp may be conducted continuously or stepwise. Typically, the alkaline solution is kept in a storage tank and transferred to a mixer or a mixing tank where it is mixed with the xylan-rich fiber material. Step c) may thus occur in a mixing tank or a mixer.

The alkaline solution may comprise NaOH and/or at least partially oxidized white liquor. Alternatively, the alkaline solution may comprise totally oxidized white liquor. It is advantage to use totally oxidized white liquor if a step of alkaline bleaching is following step d) especially if the bleaching stage comprises the addition of oxidizing bleach chemicals, such as oxygen and/or hydrogen peroxide, because by using totally oxidized white liquor instead of oxidized white liquor, the introduction of thiosulphate to the bleaching stage is minimized. This is an advantage since thiosulphate in the oxidized white liquor would consume oxidizing bleach chemicals. Hence, step d) may occur before the step f), wherein the alkaline solution is NaOH or totally oxidized white liquor.

The alkali charge calculated as NaOH in the step c) may be from 10% to 400%, preferably from 20% to 200% based on dry weight of the xylan-rich fiber material. Hereby, the alkaline solution may be described as a strong alkaline solution. A strong alkaline solution promotes swelling of the xylan-rich fiber material. The alkaline swelling of the xylan-rich fiber material helps to dissolve the xylan from the fibers and much of the xylan in the fibers then passes into the liquid phase of the xylan-rich alkaline slurry. The alkali charge calculated as NaOH in the step c) may be higher than 10%, preferably higher than 20%. At low alkali concentration, the degree of xylan solubilization may become insignificant. On the other hand, at too high alkali concentration, the degree of xylan solubilization may be reduced from a maximum level. The alkali charge calculated as NaOH in the step c) may therefore be lower than 400%, preferably lower than 200%.

The alkali concentration in the xylan-rich alkaline slurry may be from 0.5 to 4.0 mol/L, preferably from 1.0 to 3.0 mol/L.

The initial ratio between the weight of the alkaline solution and the dry weight of the xylan-rich fiber material may be from 100:1 to 1:1, preferably from 50:1 to 1.5:1, more preferably from 20:1 to 2:1. The weight of the alkaline solution in this context means the weight of the alkaline solution including the weight of the water in the xylan-rich fiber material. Initial in this context means before the step of mixing.

The method may further comprise the step of:
g) diluting the xylan-rich alkaline slurry such that the weight of the slurry increases by 0.5-200 times, preferably by 0.75-100 times, more preferably by 1-50 times, wherein step g) occurs before step d). The step of diluting has the technical effect that a more even distribution of alkali and xylan may be achieved in the pulp mixture.

The wood pulp may origin from a softwood feedstock, a hardwood feedstock, recycled paper, recycled board, or a combination thereof. Preferably, the wood pulp origins from a softwood feedstock, a hardwood feedstock, or a combination thereof. It should be mentioned that the wood pulp and the xylan-rich fiber material may originate from the same feedstock. Hereby, a pulp mixture with improved properties based on 100% hardwood feedstock and having translocated xylan may be obtained.

The method may comprise a step of:
k) delignification and/or bleaching of the wood pulp,
wherein the kappa number of the wood pulp is less than 80, preferably less than 40, if step d) occurs before step e) and the kappa number of the wood pulp is less than 30, preferably less than 15, if step d) occurs before step f). The kappa number being analysed by standard method SS-ISO 302:2016.

An advantage of delignifying the wood pulp prior to step d) is that the wood pulp becomes more accessible for sorption of xylan than if provided in the form of wood chips or less delignified wood pulp.

At least 10%, preferably at least 30%, more preferably at least 50% of xylan in the xylan-rich fiber material may be solubilized prior to step d). A higher amount of solubilized xylan before mixing may enable a higher amount sorbed xylan on the pulp mixture.

The step of mixing the xylan-rich fiber material with the alkaline solution may be conducted at low temperature to moderate temperature, such as less than 80° C. or less than 60° C. Step c) may be conducted at a temperature of below 60° C., and wherein the time between step c) and step d) is less than 1 hour, or less than 10 minutes, or less than 1 minute. Alternatively, step c) may be conducted at a temperature between 5 to 100° C. or between 10 to 80° C. or between 20 to 60° C.

The alkali charge during step e) may be 10-70 kg/ton of effective alkali from at least partially oxidized white liquor and/or sodium hydroxide. Alternatively, the alkali charge during step e) may be 20-60 kg/ton or 30-50 kg/ton of effective alkali from at least partially oxidized white liquor and/or sodium hydroxide.

The alkali charge during step f) may be 2-30 kg/ton of effective alkali from totally oxidized white liquor and/or sodium hydroxide.

The pH of the pulp mixture may decrease from a first value to a second value from the point of mixing in step d) to the end of step e) or step f), and wherein the second value is from 8 to 12, preferably from 9 to 11. Hereby, the starting pH value may be higher than the final pH value. The first value may be 11 to 14 or between 11.5 to 13.5. During the oxygen delignification or during the bleaching, alkali is used to react with lignin which causes the pH to drop. A pH drop favours the re-sorption of xylan since the solubility of xylan decreases with decreasing pH value. The pH measurement may be made using a calibrated pH meter at 25 degrees Celsius.

Step f) may be a part of an ECF or TCF bleaching sequence, such as alkaline peroxide bleaching or alkaline extractions, or as alkaline extractions reinforced with peroxide and/or oxygen.

The method may comprise a step of:
h) drying the pulp mixture thus obtaining a market pulp. Stated differently, the bleached pulp mixture may be dried thus obtaining a market pulp.

### BRIEF DESCRIPTION OF THE DRAWINGS

These and other aspects of the present invention will now be described in more detail, with reference to the appended drawings showing currently preferred embodiments of the invention.

FIG. 1 shows a previous method for producing chemical wood pulp;

FIG. 2 shows a method for production of chemical wood pulp wherein xylan-rich material are mixed with an alkaline solution and added to diluted wood pulp according to at least one example embodiment of the inventive concept;

FIG. 3 shows a method for production of chemical wood pulp according to at least one example embodiment of the inventive concept;

FIG. 4 shows a method for production of chemical wood pulp according to at least one example embodiment of the inventive concept.

### DETAILED DESCRIPTION

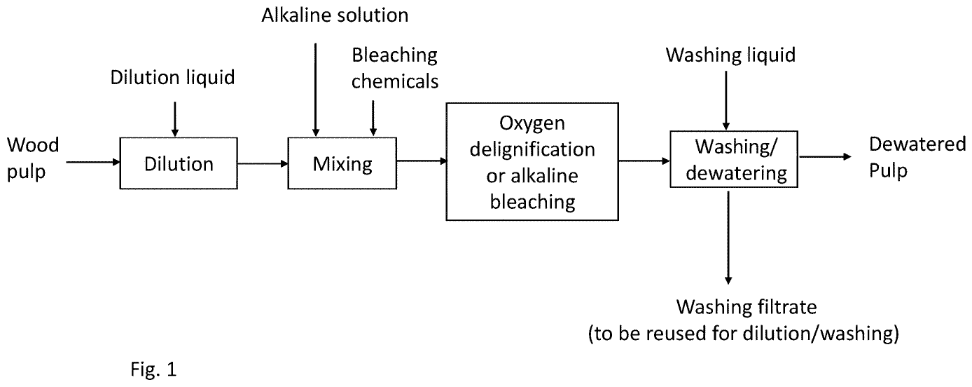

FIG. 1 illustrates a previous method for production of chemical wood pulp. In this method, wood pulp is diluted by a dilution liquid. The dilution are typically conducted in a thinning screw. The diluted wood pulp is then mixed with an alkaline solution and bleaching chemicals in a mixer to oxygen delignify and/or bleach the wood pulp. After the bleaching, the wood pulp is washed/dewatered.

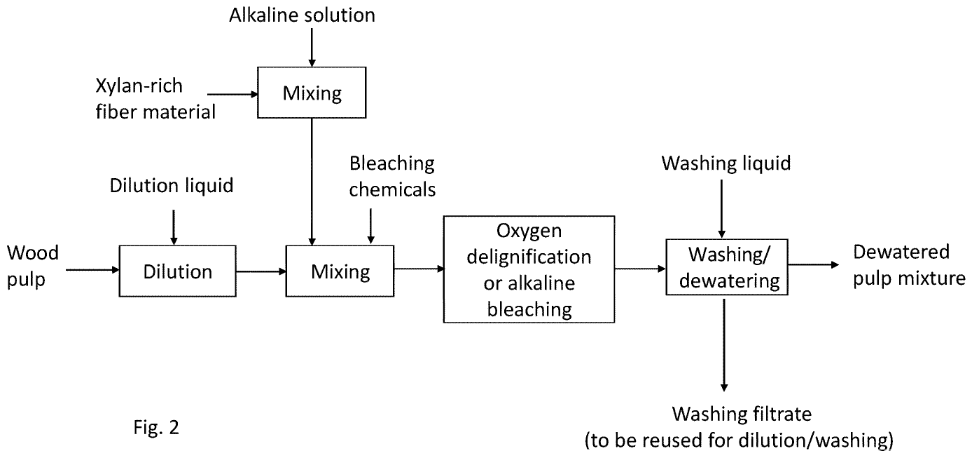

FIG. 2 shows a method for production of chemical wood pulp according to an embodiment of the inventive concept. As may be seen, the method comprises the steps of:
a) providing wood pulp;
b) providing xylan-rich fiber material; the xylan-rich fiber material being at least partly delignified;
c) mixing the xylan-rich fiber material with an alkaline solution thus forming a xylan-rich alkaline slurry;
d) adding the xylan-rich alkaline slurry to the wood pulp thus providing a pulp mixture,
   wherein the step d) is followed by at least one of:
e) oxygen delignification step and/or,
f) alkaline bleaching step,
to enable reuse of the alkali in the xylan-rich alkaline slurry from step c) in step e) and/or step f). The method in FIG. 2 further comprises a step of diluting the wood pulp prior to step d). The wood pulp may be diluted from an initial dry matter content of 15-35% to a dry matter content of approximately 10%. Hence, the xylan-rich slurry is added to a diluted wood pulp. The dilution with dilution liquid may be conducted in a thinning screw.

The xylan-rich slurry may be added to the wood pulp in a mixer, together or separately with bleaching chemicals. The pulp mixture is then oxygen delignified and/or bleached. In the oxygen delignification and/or bleaching step, the released xylan sorbs onto the fibers and the pulp has an increased xylan content.

The method may further comprise a step of washing and dewatering the pulp mixture after step e) or f) thus forming a dewatered pulp mixture and a washing filtrate. The washing filtrate may be reused as a dilution/washing liquid and be added to the wood pulp fibers. The resulting dewatered pulp mixture typically has a dry matter content of 15-35%.

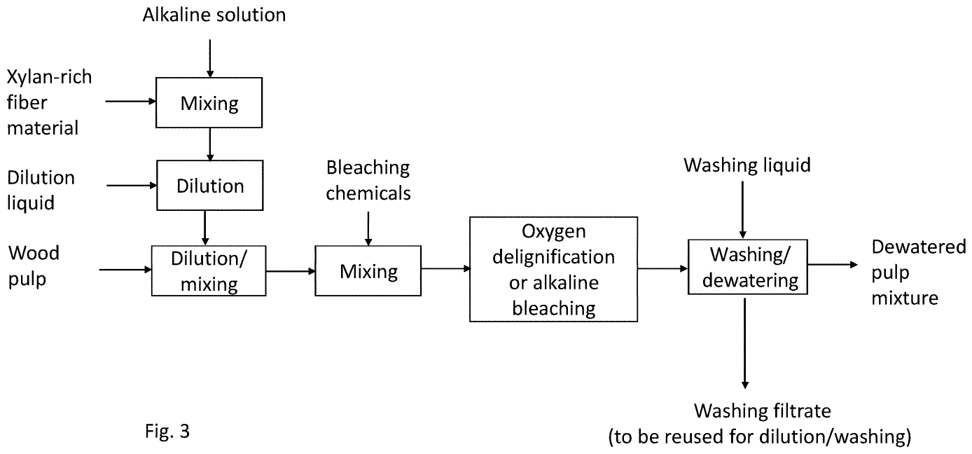

FIG. 3 shows a method for production of chemical wood pulp according to an embodiment of the inventive concept. Steps a) to f) in FIG. 3 are the same as those described in FIG. 2 but instead of diluting the wood pulp, the method comprises a step of diluting the xylan-rich slurry obtained in step c), wherein the dilution occurs before step d). Hereby, a diluted xylan-rich slurry is added to the wood pulp. The diluted xylan-rich slurry may be added to the wood pulp in the thinning screw. Similar to method described in FIG. 2, the pulp mixture obtained after step d) has a dry matter content of approximately 10%.

Similar to the method in FIG. 2, bleaching chemicals are added to the pulp mixture and the pulp mixture is then oxygen delignified and/or bleached. Also, similar to the method described in FIG. 2, the method further comprises a step of washing and dewatering the pulp mixture thus forming a dewatered pulp mixture and a washing filtrate. This step occurs after the step e) or f). The washing filtrate may then be reused as a washing liquid and be added to the xylan-rich slurry. The resulting dewatered pulp mixture typically has a concentration of 15-35% by weight.

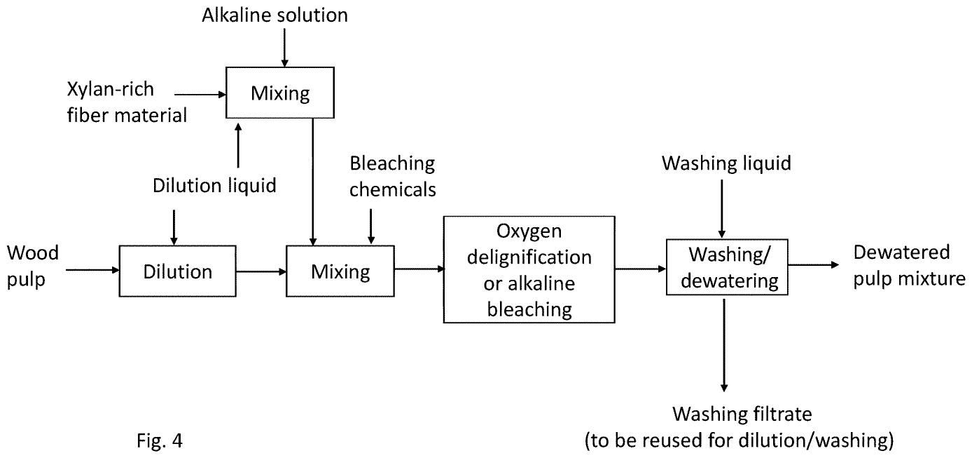

FIG. 4 illustrates yet another embodiment of a method to provide a pulp mixture according to the inventive concept. Again, steps a) to f) are the same as those described in FIGS. 2 and 3. However, this method comprises both a step of diluting the wood pulp and a step of diluting the alkaline slurry before step d). Hence, both the wood pulp provided in step a) and the alkaline slurry obtained in step c) are diluted with washing filtrate before being mixed. Hereby, a diluted wood pulp is mixed with a diluted alkaline slurry. The washing filtrate generated from the dewatering step may be reused either to dilute the wood pulp or the alkaline slurry or both.

The method of the present invention will now be described by examples.

### Example 1

Oxygen Delignification with Addition of Xylan-Rich Alkaline Slurry

A sample of “wood pulp” in the form of a never-dried softwood kraft pulp was collected from an industrial kraft pulp mill after the last wash press before oxygen delignification. This pulp was further laboratory washed by dilution with water to 2-3% pulp consistency followed by 30 minutes of leaching in a plastic bucket. 10 L of this pulp suspension was then dewatered in a nylon cloth bag (100 mesh) to about 15-20% pulp consistency, washed with 20 L of water, centrifuged to about 35% consistency and finally washed again with 20 L of water and centrifuged to about 35% consistency. The procedure was repeated to wash enough pulp for the oxygen delignification trials. The laboratory washed pulp (Sample ID: 1.1) had a kappa number of 27.9 and a dry content of 33%.

A sample of once-dried industrially produced fully bleached hardwood kraft pulp (Sample ID: 1.2) in the form of pulp sheets was used as the “xylan-rich fiber material”. The xylan content of the hardwood pulp was 24.0% using same analysis methods as in Table 1.2 and Table 2.2. The kappa number of this sample was 5.4 analyzed by standard method SS-ISO 302:2016. Pulp brightness was >88.5% ISO analyzed by ISO 3688 and SS ISO 2470-1.

The following samples were prepared for oxygen delignification trials:

### Reference 100% SW (Sample ID: 1.3)

100 g of softwood pulp ID 1.1 (based on dry solids) was oxygen delignified according to the conditions in Table 1.1.

### Reference 93% SW/7% HW (Sample ID 1.4)

7 g of hardwood pulp ID 1.2 (based on dry solids) in the form of pieces from a pulp sheet was diluted in 200 g of deionized water and the pulp was left to soak for 10 minutes. Then the fibers were dispersed using a hand blender with smoothened blades for about 20 seconds until the fibers were well dispersed. The dispersed fiber slurry was added to 93 g of softwood pulp ID 1.1 (based on dry solids). This pulp mixture was oxygen delignified according to the conditions in Table 1.1

### 7% HW: Addition of Xylan-Rich Alkaline Slurry to Softwood Pulp (Sample ID 1.5)

A batch of 7 g of hardwood pulp ID 1.2 (based on dry solids) was teared into small pieces and put into a plastic bag together with 35 g of 10% NaOH (equal to 50% NaOH/weight of dry pulp) and 35 g of additional water (deionized water+the moisture in the air-dry hardwood pulp). Alkaline solution to xylan-rich fiber material ratio was 10:1. The plastic bag was sealed, and the liquid was distributed evenly by gentle finger pressing. The plastic bag was introduced into a water bath at 50° C. and the strong alkali treatment was conducted for 10 minutes. Then, the bag was taken from the water bath and opened with a scissor. The xylan-rich alkaline slurry in the plastic bag was added directly to 93 g of softwood pulp ID 1.1 (based on dry solids). Thereafter, a solution containing MgSO₄ (0.5 g MgSO₄), make-up NaOH (0.5 g NaOH) and deionized water (dilution water) was added to the pulp mixture to form a pulp mixture having 10% pulp consistency. This pulp mixture was oxygen delignified according to the conditions in Table 1.1

### 7% HW: Addition of Xylan-Rich Alkaline Slurry to the Dilution Water (Sample ID 1.6)

Another batch hardwood pulp ID 1.2 (based on dry solids) was treated with strong alkali using the same conditions and procedures as for Sample ID 1.5. However, instead of adding the xylan-rich alkaline slurry directly to the softwood pulp it was first diluted with a solution containing MgSO₄ (0.5 g MgSO₄), make-up NaOH (0.5 g NaOH) and deionized water (dilution water) and thereafter this mixture/slurry was added to the softwood pulp. This pulp mixture was oxygen delignified according to the conditions in Table 1.1

### Oxygen Delignification

The pulp suspensions (see Table 1.1) were charged into steel autoclaves, oxygen gas was added to a pressure of 15 bars and the autoclaves were inserted into a a hot-air oven (CRS Reactor Engineering AB, Stenkullen, Sweden). A two-stage oxygen delignification was performed, first stage was performed at 90° C. and the second stage at 100° C., in between the two stages the pressure in the autoclaves was reduced to 5 bars. A 40-minute temperature ramp and 30 minutes residence time at full temperature was used during the first stage. For the second stage a 10-minute temperature ramp and 60 minutes residence time at full temperature was used.

TABLE 1.1
Pulp mixtures and chemicals used in oxygen delignification trials

| | Softwood | Hardwood | NaOH | MgSO₄ | |
|---|---|---|---|---|---|
| Sample | pulp ID 1.1 | pulp ID 1.2 | (g/kg | (g/kg | Pulp |
| ID | (g) | (g) | of pulp) | of pulp) | consistency |
| 1.3 | 100 | — | 35 | 5 | 10% |
| 1.4 | 93 | 7 | 35 | 5 | 10% |
| 1.5 | 93 | 7* | 5** | 5 | 10% |
| 1.6 | 93 | 7* | 5** | 5 | 10% |

*Amount of pulp treated with NaOH to form a xylan-rich alkaline slurry
**Make-up NaOH, plus NaOH is also part of the xylan-rich alkaline slurry. Total charge of NaOH was 35 + 5 g/kg of pulp considering the NaOH charge in both the alkaline treatment and the make-up NaOH.

Kappa number, and xylan content were analyzed after oxygen delignification, see results in Table 1.2.

TABLE 5.1
Results after oxygen delignification.

| | | Pulp | Xylan | |
|---|---|---|---|---|
| Sample | Kappa | brightness** | content *** | Final |
| ID | number* | (% ISO) | (%) | pH**** |
| 1.3 | 9.4 | 46.4 | 7.9 | 10.9 |
| 1.4 | 9.1 | 48.0 | 8.9 | 11.3 |
| 1.5 | 8.6 | 50.3 | 8.7 | 11.7 |
| 1.6 | 8.7 | 46.5 | 8.7 | 12.0 |

*Kappa number analyzed by standard method SS-ISO 302:2016
**Pulp brightness analyzed by standard method ISO 3688 and SS ISO 2470-1
*** Xylan content reported as anhydro sugar content of xylan, carbohydrate analysis analyzed by standard method ISO 21437:2020. Klason lignin and acid soluble lignin (ISO 21436:2020) and ash content (ISO-1762:2019) was included in the total mass balance to calculate the final anhydro sugar contents.
****Final pH was measured in the filtrate after oxygen delignification. pH was measured according to ISO 10523:2012

The two samples with addition of xylan-rich alkaline slurry (ID 1.5 and ID 1.6) had higher xylan content than the softwood reference (ID 1.3) and only slightly lower xylan content as the reference with 7% hardwood fibers (ID 1.4). This result shows that a very high portion of xylan is maintained in the pulp mixture also after oxygen delignification. Part of the increase in xylan content for samples ID 1.5 and ID 1.6 is due to xylan adsorption taking place after the mixing of the xylan-rich alkaline slurry and the wood pulp. This means that solubilized xylan in the xylan-rich alkaline slurry can adsorb both onto the hardwood fibers and the softwood fibers in the pulp mixture. Another contribution to the xylan content is the xylan remaining in the hardwood fibers after the alkaline treatment. The hardwood fibers also contribute to the total yield of the pulp mixture and this procedure simplifies the process since no extra separation steps is needed after the alkaline treatment for separation of fibers and xylan-rich alkaline liquor.

The NaOH used in the alkaline treatment is used again in the oxygen delignification treatment. This procedure demonstrates a double use of the same alkali since the alkali is used first for solubilization of xylan during the alkaline treatment and then as a reactant in the reactions with lignin during oxygen delignification.

In these experiments, make-up NaOH was added to compensate for an anticipated consumption during the alkaline treatment, however the final pH values show that only very small amount of NaOH could have been consumed during the alkaline treatment of the xylan-rich fiber material.

### Paper Sheet Preparation and Testing

Paper properties was tested for the four oxygen delignified pulps after sheet preparation described below. The pulps were first pH adjusted to pH 5.5-6.0 and then formed into paper sheets with a basis weight of about 370 g/m² using a laboratory sheet former. The formed laboratory sheets were pressed twice for 10 minutes at 50 bars pressure. The pressed sheets were dried at 90° C. and 90% relative humidity for 60 minutes.

These pulps were then wet disintegrated in accordance with standard method ISO 5263-1:2004. Laboratory hand sheets was prepared from unbeaten pulp. Hand sheet with a basis weight of about 60 g/m² was formed and pressed in accordance with standard method EN ISO 5269-1. The pressed hand sheets were dried and conditioned in a climate room for at least 24 hours at 23±1° C. and 50±2% relative humidity in accordance with standard method EN ISO 20187.

Tensile index was tested using a Lorentzen & Wettre tensile tester apparatus, basis weight of the hand sheets was measured in accordance with standard method ISO 536:2012 and ISO 5269-1:2005 and tensile index was tested in accordance with standard method ISO 1924-3. The result from tensile strength tests is shown in Table 6.1.

TABLE 1.3
Tensile index testing results of unbeaten pulps

| | | Produced | Tensile |
|---|---|---|---|
| | | from | index |
| Sample ID | Sample desciption | sample ID | (kNm/kg) |
| 1.7 | Reference 100% SW | 1.3 | 33.9 |
| 1.8 | Reference 93% SW/7% HW | 1.4 | 34.9 |
| 1.9 | Xylan-rich alkaline slurry to SW | 1.5 | 37.5 |
| 1.10 | Diluted xylan-rich alkaline slurry | 1.6 | 38.5 |
| | to SW | | |

As shown in Table 1.3, tensile index was improved by 3.6-4.6 kNm/kg for paper sheets (ID 1.9 and ID 1.10) produced from pulps with addition of xylan-rich alkaline slurry compared to the reference with 100% softwood pulp (ID 1.7). Addition of just hardwood pulp without any alkaline treatment in between (ID 1.8) did not result in the same high increase in tensile strength. These results demonstrate that a alkaline treatment of a xylan-rich fiber material, followed by mixing with a wood pulp prior to oxygen delignification is an effective method to enhance the tensile strength of the resulting pulp mixture.

### Example 2

Peroxide Bleaching with Addition of Xylan-Rich Alkaline Slurry

A sample of “wood pulp” in the form of a never-dried softwood kraft pulp was collected from an industrial kraft pulp mill after the last wash press prior to pulp bleaching. This pulp was further laboratory washed by dilution with water to 2-3% pulp consistency followed by 30 minutes leaching in a plastic bucket. 10 L of this pulp suspension was then dewatered in a nylon cloth bag (100 mesh) to about 15-20% pulp consistency, washed with 20 L of water, centrifuged to about 35% consistency and finally washed again with 20 L of water and centrifuged to about 35% consistency. The procedure was repeated to wash enough pulp for the bleaching trials. The laboratory washed pulp (Sample ID: 2.1) had a kappa number of 10.2 and a dry content of about 33.1%.

The washed pulp was firstly bleached with a TCF bleaching sequence Q-OP-Q sequence prior to the final PO bleaching step. The method described below is also applicable using other bleaching sequences (e.g. TCF or ECF sequences) where alkaline bleaching steps is included.

The first Q step (chelating step with EDTA) was performed at 85° C. at 10% pulp consistency for 60 minutes in plastic bags submerged into a temperature regulated water bath. 0.7 g of EDTA was added per kg pulp (g per kg 100% dry pulp) and 3.2 g H₂SO₄ was added per kg pulp (g per kg 100% dry pulp) for pH adjustment.

The OP step was performed at 100° C. at 10% pulp consistency for 80 minutes plus in steel autoclaves submerged into a temperature regulated bath with polyethylene glycol. The H₂O₂, NaOH and MgSO₄ charges were 12, 10 and 0.5 g/kg pulp (g per kg 100% dry pulp), respectively. The pulps mixtures with chemicals were but into plastic bags, which were sealed before being introduced into autoclaves. Deionized water was added in the autoclaves to improve heat transfer between the autoclave wall and the plastic bag.

Oxygen gas was added to a pressure of 5 bars before introducing the autoclaves in the bath. Kappa number after OP bleaching was 6.6 and brightness was 72.3% analyzed by standard method (Kappa number: SS-ISO 302:2016 and Brightness: ISO 3688/SS ISO 2470-1).

The second Q step (chelating step with EDTA) was performed at 85° C. at 10% pulp consistency for 60 minutes in plastic bags submerged into a temperature regulated water bath. 1.0 g of EDTA was added per kg pulp (g per kg 100% dry pulp) and 1.3 g H₂SO₄ was added per kg pulp (g per kg 100% dry pulp) for pH adjustment. The pulp after second Q-step is referred to as sample ID 2.2

The same sample of once-dried industrially produced fully bleached hardwood kraft pulp as in Example 1 (ID 1.2) was used as the “xylan-rich fiber material” for the reference samples.

The hardwood pulp ID 1.2 (g of dry pulp) was dispersed in water water at 2% consistency and left to soak for 10 minutes, defibrated with a hand blender with smoothened blades for 40 seconds seconds, dewatered in a büchner funnel and air dried at room temperature (20° C.) to form a more porous sheet than the paper machine sheet. This sample (referred to as sample ID 2.13) was used as “xylan-rich fiber material” in the alkaline treatments in Example 2.

The following samples were prepared for peroxide bleaching (PO) experiments:

### Reference 100% SW (Sample ID: 2.3)

50 g of Q-OP-Q-bleached softwood pulp ID 2.2 (based on dry solids) was peroxide bleached according to the conditions in Table 2.1.

### Reference 96.5% SW/3.5% HW (Sample ID 2.4)

1.75 g of hardwood pulp ID 1.2 (based on dry solids) in the form of pieces from a machine sheet was diluted in 120 g of deionized water and the pulp was left to soak for 10 minutes. Then the fibers were dispersed using a hand blender with smoothened blades for about 20 seconds until the fibers were well dispersed. The dispersed fiber slurry was then diluted with a solution containing MgSO₄ (0.06 g MgSO₄), hydrogen peroxide (1.45 g H₂O₂) and deionized water (dilution water) and thereafter this mixture/slurry was added to the 48.25 g of Q-OP-Q-bleached softwood pulp ID 2.2 (based on dry solids). This pulp mixture was peroxide bleached according to the conditions in Table 2.1.

### 3.5% HW: Addition of Diluted Xylan-Rich Alkaline Slurry to Softwood Pulp (Sample ID 2.5)

A batch of 1.75 g of hardwood pulp ID 2.13 (based on dry solids) was teared into small pieces and put into a plastic bag together with 8.75 g of 10% NaOH (equal to 50% NaOH/weight of dry pulp) and 8.75 g of additional water (deionized water+the moisture in the air-dry hardwood pulp). Alkaline solution to xylan-rich fiber material ratio was 10:1. The plastic bag was sealed, and the liquid was distributed evenly by gentle finger pressing. The plastic bag was introduced into a water bath at 50° C. for 10 minutes residence time. Then, the bag was taken from the water bath and opened with a scissor. The xylan-rich alkaline slurry was first diluted with a solution containing MgSO₄ (0.06 g MgSO₄), hydrogen peroxide (1.45 g H₂O₂) and deionized water (dilution water) and thereafter this mixture/slurry was added to the softwood pulp. No make-up NaOH was added in the peroxide bleaching trial. This pulp mixture was peroxide bleached according to the conditions in Table 2.1.

### Reference 93% SW/7% HW (Sample ID 2.6)

3.5 g of hardwood pulp ID 1.2 (based on dry solids) in the form of pieces from a machine sheet was diluted in 120 g of deionized water and the pulp was left to soak for 10 minutes. Then the fibers were dispersed using a hand blender with smoothened blades for about 20 seconds until the fibers were well dispersed. The dispersed fiber slurry was then diluted with a solution containing MgSO₄ (0.06 g MgSO₄), hydrogen peroxide (1.45 g H₂O₂) and deionized water (dilution water) and thereafter this mixture/slurry was added to the 46.5 g of Q-OP-Q-bleached softwood pulp ID 2.2 (based on dry solids). This pulp mixture was peroxide bleached according to the conditions in Table 2.1.

### 7% HW: Addition of Diluted Xylan-Rich Alkaline Slurry to Softwood Pulp (Sample ID 2.7)

A batch of 3.5 g of hardwood pulp ID 2.13 (based on dry solids) was teared into small pieces and put into a plastic bag together with 8.75 g of 10% NaOH (equal to 50% NaOH/weight of dry pulp) and 8.75 g of additional water (deionized water+the moisture in the air-dry hardwood pulp). Alkaline solution to xylan-rich fiber material ratio was 5:1. The plastic bag was sealed, and the liquid was distributed evenly by gentle finger pressing. The plastic bag was introduced into a water bath at 50° C. for 10 minutes residence time. Then, the bag was taken from the water bath and opened with a scissor. The xylan-rich alkaline slurry was first diluted with a solution containing MgSO₄ (0.06 g MgSO₄), hydrogen peroxide (1.45 g H₂O₂) and deionized water (dilution water) and thereafter this mixture/slurry was added to the softwood pulp. No make-up NaOH was added in the peroxide bleaching trial. This pulp mixture was peroxide bleached according to the conditions in Table 2.1.

### Hydrogen Peroxide Bleaching

The last bleaching step, the PO step (pressurized peroxide bleaching), was performed at 105° C. at 10% pulp consistency in steel autoclaves introduced into a temperature regulated bath with polyethylene glycol. The pulps mixtures with chemicals were but into plastic bags which were sealed before being introduced into autoclaves. Deionized water was added in the autoclaves to improve heat transfer between the autoclave wall and the plastic bag. Oxygen gas was added to a pressure of 5 bars. A 15-minute temperature ramp was used followed by 250 minutes residence time at 105° C. Chemical charges were made according to Table 2.1.

TABLE 2.1
Pulp mixtures and chemicals used in peroxide bleaching trials

| | | | NaOH | MgSO₄ | |
|---|---|---|---|---|---|
| Sample | Softwood | Hardwood | (g/kg | (g/kg | Pulp |
| ID | pulp (g) | pulp (g) | pulp) | pulp) | consistency |
| 2.3 | 50 | — | 17.5 | 1.2 | 10% |
| 2.4 | 48.25 | 1.75 | 17.5 | 1.2 | 10% |
| 2.5 | 48.25 | 1.75* | —** | 1.2 | 10% |
| 2.6 | 46.5 | 3.5 | 17.5 | 1.2 | 10% |
| 2.7 | 46.5 | 3.5* | —** | 1.2 | 10% |

*Amount of pulp treated with NaOH to form a xylan-rich alkaline slurry
**Alkali only added via the xylan-rich alkaline slurry, no make-up alkali was added. Total charge of NaOH was 17.5 g/kg pulp i.e. all NaOH was added during the alkaline treatment.

Brightness, xylan content, and final pH were analyzed after the PO-step, see results in Table 2.2.

TABLE 2.2
Results after PO-bleaching.

| | Pulp | Xylan | |
|---|---|---|---|
| Sample | brightness* | content** | |
| ID | (% ISO) | (%) | Final pH*** |
| 2.3 | 88.9 | 7.4 | 11.0 |
| 2.4 | 88.7 | 7.7 | 10.6 |
| 2.5 | 88.6 | 7.7 | 10.7 |
| 2.6 | 89.3 | 8.1 | 10.8 |
| 2.7 | 88.9 | 8.1 | 10.9 |

*Pulp brightness analyzed by standard method ISO 3688 and SS ISO 2470-1
**Xylan content based on the anhydrosugar contents of arabinan + xylan, carbohydrate analysis analyzed by standard method ISO 21437:2020. Klason lignin and acid soluble lignin (ISO 21436:2020) and ash content (ISO-1762:2019) was included in the total mass balance to calculate the sugar contents.
***Final pH was measured in the filtrate after peroxide bleaching. pH was measured according to ISO 10523:2012

The results of pulp brightness tests show no significant differences in brightness between the samples. Also, pH was similar for all five samples indicating that the consumption of NaOH during the alkali treatment is insignificant at the relatively gentle conditions used in these trials (low temperature and short time).

The analysis of xylan content shows that the increase in xylan content is at the same level both when adding xylan-rich alkaline slurry or hardwood pulp, indicating a highly efficient sorption of solubilized xylan from the xylan-rich alkaline slurry during the peroxide bleaching step. The adsorption efficiency of xylan sorption was even higher than in Example 1. A plausible explanation for this is that the fiber wall of the softwood pulp fibers was more accessible for sorption of xylan when being partially bleached (ID 2.2) than after brownstock washing (ID 1.1).

### Paper Sheet Preparation and Testing

Paper properties was tested for the five fully bleached pulps after sheet preparation according to the methods and procedures used in Example 1. Results of tensile index for unbeaten pulps are shown in Table 2.3.

TABLE 2.3
Tensile index testing results of unbeaten pulps

| | | Produced | Tensile |
|---|---|---|---|
| Sample | | from | index |
| ID | Sample description | sample ID | (kNm/kg) |
| 2.8 | Reference 100% SW | 2.3 | 20.4 |
| 2.9 | Reference 96.5% SW/3.5% HW | 2.4 | 22.2 |
| 2.10 | 3.5% diluted xylan-rich alkaline slurry | 2.5 | 25.1 |
| | to SW | | |
| 2.11 | Reference 93% SW/7% HW | 2.6 | 24.0 |
| 2.12 | 7% diluted xylan-rich alkaline slurry to | 2.7 | 26.3 |
| | SW | | |

As shown in Table 2.3, the treatment with xylan-rich alkaline slurry increased tensile index by 4.7-5.9 kNm/kg which is significantly higher than if just adding the same amount of dispersed hardwood pulp to the wood pulp prior to PO-bleaching. These results demonstrates that alkaline treatment of a xylan-rich fiber material prior to alkaline bleaching is an efficient method to improve the tensile strength of the pulp.

### Example 3

### Conditions During Strong Alkali Treatment

Separate experiments were made to determine the extent of xylan solubilization during the alkaline treatment. The conditions used during the alkali treatment is shown in Table 3.1.

TABLE 3.1
Conditions used during alkaline treatment.

| | | | | Alkaline | | |
|---|---|---|---|---|---|---|
| | | | | solution | | |
| | HW | HW | NaOH | to xylan-rich | Temper- | Treatment |
| Sample | Pulp | Pulp | (g/g | fiber | ature | time |
| ID | ID | (g) | pulp) | material ratio | (° C.) | (minutes) |
| 3.1 | 2.13 | 1.75 g | 0.5 | 10:1 | 50 | 10 |
| 3.2 | 2.13 | 3.5 g | 0.25 | 5:1 | 50 | 10 |
| 3.3 | 1.2 | 5.0 g | 1.0 | 10:1 | 50 | 10 |
| 3.4 | 1.2 | 5.0 g | 1.0 | 10:1 | 50 | 1 |
| 3.5 | 1.2 | 5.0 g | 1.8 | 10:1 | 50 | 10 |

The procedure for the alkaline treatment was same as in Example 2 for sample 3.1 and Sample 3.2. However, after the opening of the plastic bag (after the treatment in the water bath) the treated pulp was diluted with 100 ml of deionized water. 10 minutes after dilution the diluted xylan-rich alkaline slurry was dewatered in a büchner funnel with a nylon filter cloth (100 mesh). The filtrate was returned once through the pulp in the funnel. Thereafter the pulp was washed with 1.5 L of deionized water.

For samples 3.3, 3.4 and 3.5 hardwood pulp ID 1.2 was used (i.e. teared pieces from a pulp sheet), apart from that all procedures were same as for sample 3.1 and 3.2.

After alkali treatment and washing the pulps was dried at 105(° C.) and pulp yield and xylan content of the treated pulps were analyzed after drying, results are shown in Table 3.2. Based on pulp yield and xylan content the amount of solubilized xylan (g solubilized xylan per dry weight of hardwood pulp) was calculated and the percentage of solubilized xylan based on the xylan content of the raw material.

TABLE 3.2
Results after alkaline treatment

| | | Xylan | Xylan | | |
|---|---|---|---|---|---|
| | | content | content | | Percentage |
| | Pulp | untreated | after | Solubilized | of |
| Sample | yield | pulp (ID 1.2) | treatment | xylan | solubilized |
| ID | (%) | (g/g pulp) | (g/g pulp) | (g/g pulp)* | xylan (%)** |
| 3.1 | 83.4 | 0.24 | 0.11 | 0.15 | 63% |
| 3.2 | 87.4 | 0.24 | 0.12 | 0.13 | 55% |
| 3.3 | 77.8 | 0.24 | 0.04 | 0.21 | 87% |
| 3.4 | 78.2 | 0.24 | 0.06 | 0.20 | 81% |
| 3.5 | 80.2 | 0.24 | 0.07 | 0.19 | 78% |

*Solubilized xylan = xylan content of untreated pulp − (xylan content after treatment × pulp yield)
**Percentage of solubilized xylan = Solubilized xylan / xylan content in untreated pulp

The results show that more than 50% of the xylan in the untreated hardwood pulp was solubilized during the alkali treatment. The results of Sample ID 3.4 show that a major part of the xylan in the untreated hardwood sample is solubilized within one minute after mixing with the alkaline solution. This means that a short treatment time can be used with similar result, i.e. similar percentage of solubilized xylan, thus reducing the size/length of vessels or piping used for the alkali treatment.

The results in Table 3.2 further shows that the yield loss during the alkaline treatment is to mostly due to xylan solubilization, i.e. the treatment is highly selective to solubilize xylan. And as shown in Example 1 and Example 2, the solubilized xylan is to a large extent sorbed onto the pulp fibers of the pulp mixture during oxygen delignification or alkaline bleaching.

The person skilled in the art realizes that the present invention by no means is limited to the embodiments described above. On the contrary, many modifications and variations are possible within the scope of the appended claims.

1. A method for production of chemical wood pulp, wherein the method comprises:
a) providing wood pulp;
b) providing xylan-rich fiber material, the xylan-rich fiber material being priorly delignified to a kappa number less than 50;
c) mixing the xylan-rich fiber material containing at least 15% xylan with an alkaline solution thus forming a xylan-rich alkaline slurry containing fibers, alkali and dissolved xylan;
d) adding the xylan-rich alkaline slurry containing fibers, alkali and dissolved xylan to the wood pulp thus providing a pulp mixture,
wherein the step d) is followed by at least one of:
e) oxygen delignification step and/or,
f) alkaline bleaching step,
thereby reusing the alkali in the xylan-rich alkaline slurry from step c) in step e) and/or step f).

2. The method according claim 1, wherein the xylan-rich fiber material has a dry matter content of at least 20%, preferably at least 30%.

3. The method according to claim 1, wherein the alkaline solution comprises NaOH and/or at least partially oxidized white liquor.

4. The method according to claim 1, wherein the step d) occurs before the step f), wherein the alkaline solution is NaOH or totally oxidized white liquor.

5. The method according to claim 1, wherein the alkali charge calculated as NaOH in the step c) is from 10% to 400%, preferably from 20% to 200% based on dry weight of the xylan-rich fiber material.

6. The method according to claim 1, wherein the alkali concentration in the xylan-rich alkaline slurry is from 0.5 to 4.0 mol/L, preferably from 1.0 to 3.0 mol/L.

7. The method according to claim 1, wherein the initial ratio between the weight of the alkaline solution and the dry weight of the xylan-rich fiber material is from 100:1 to 1:1, preferably from 50:1 to 1.5:1, more preferably from 20:1 to 2:1.

8. The method according to claim 1, wherein the method further comprises the step of:
g) diluting the xylan-rich alkaline slurry such that the weight of the slurry increases by 0.5-200 times, preferably by 0.75-100 times, more preferably by 1-50 times, wherein step g) occurs before step d).

9. The method according to claim 1, wherein the wood pulp origins from a softwood feedstock, a hardwood feedstock, recycled paper, recycled board, or a combination thereof.

10. The method according claim 1, wherein the xylan-rich fiber material contains at least 20% xylan.

11. The method according to claim 1, wherein the xylan-rich fiber material is priorly delignified to a kappa number less than 30, preferably less than 10.

12. The method according to claim 1, wherein at least 10%, preferably at least 30%, more preferably at least 50% of xylan in the xylan-rich fiber material is solubilized prior to step d).

13. The method according to claim 1, wherein step c) is conducted at a temperature of below 60° C., and wherein the time between step c) and step d) is less than 1 hour, or less than 10 minutes, or less than 1 minute.

14. The method according to claim 1, wherein the alkali charge during step e) is 10-70 kg/ton of effective alkali from at least partially oxidized white liquor and/or sodium hydroxide.

15. The method according to claim 1, wherein the alkali charge during step f) is 2-30 kg/ton of effective alkali from totally oxidized white liquor and/or sodium hydroxide.

16. The method according to claim 1, wherein pH of the pulp mixture decreases from a first value to a second value during step d), and wherein the second value is from 8 to 12, preferably from 9 to 11.

17. The method according to claim 1, the method comprising a step of:
h) drying pulp mixture thus obtaining a market pulp.

18. The method according to claim 1, wherein the xylan-rich fiber material originates from hardwood.

19. The method according to claim 1, wherein the xylan-rich fiber material originates from agricultural feedstock, such as agricultural-based fibers.
